(19) United States
(12) Patent Application Publication
(10) Pub. No.: US 2026/0074465 A1
(43) Pub. Date: Mar. 12, 2026

(54) POWER PIN AND RECEIVING SOCKET

(71) Applicant: The ESAB Group, Inc., North Bethesda, MD (US)

(72) Inventors: Marc Hartel, Reiskirchen (DE); Dimitri Malyi, Frankfurt am Main (DE); Ulrich Kaldenbach, Grünberg (DE); Mike Engel, Pohlheim Hausen (DE); Stefan Süß, Nieder-Wiesen (DE); Alexander Fischer, Gothenburg (SE); Mattias Glädt, Nossebro (SE); Lars Gerdin, Kumla (SE); Fredrik Stjernlöf, Torslanda (SE)

(21) Appl. No.: 19/389,408

(22) Filed: Nov. 14, 2025

Related U.S. Application Data
(63) Continuation of application No. PCT/US2023/023942, filed on May 31, 2023.

(51) Int. Cl. H01R 13/629; H01R 24/38

(52) U.S. Cl. CPC H01R 13/62977; H01R 24/38

(57) ABSTRACT

An electrical connection system for an arc process system is disclosed. The electrical connection system includes a power pin and a receiving block. The power pin includes a rotational prevention element. The receiving block is configured to receive the power pin and includes a clamp assembly and one or more receptacles. The clamp assembly is configured to selectively engage the power pin to restrict axial movement of the power pin with respect to the receiving block. The one or more receptacles are configured to selectively engage the rotational prevention element and prevent rotational movement of the power pin with respect to the receiving block.

### CROSS-REFERENCE TO RELATED APPLICATION

This application claims priority to and is a continuation of International Patent Application No. PCT US/2023/023942, entitled “Power Pin and Receiving Socket,” filed May 31, 2023, the entire disclosure of which is hereby incorporated by reference in its entirety for all purposes.

### FIELD OF INVENTION

The present invention relates to the field of electrical connections and, in particular, to a connector for an arc process operation system with a multi-diameter power pin and corresponding receiving block.

### BACKGROUND

Generally, welding robots include one or more arms, a torch, and a wire feeder for feeding weld wire to the torch. The torch is disposed at a distal end of the robot and the wire feeder is disposed on or between a base of the torch and the distal end. A cable connects the wire feeder to the torch and provides a conduit for one or more of electricity, weld wire, process gas, and cooling fluid to pass from the wire feeder to the torch. Close contact between a power pin of the plug and receiving block of a socket is desirable for proper transfer of electricity and fluids from the wire feeder to the torch cable.

Often, a user climbs up the robot to connect the torch cable to the wire feeder. The user inserts a plug of the torch cable into a socket of the wire feeder with one hand, while clamping the plug to a socket with the other hand. With both hands otherwise occupied with clamping/securing the torch cable to the wire feeder, the user does not have a free hand to steady herself while perched on the robot. Thus, the user may be unsteady on the robot and could fall or improperly secure the plug of the cable with the socket. In turn, improper plug installation can cause in inefficient transfer of electricity, kinking or jamming of weld wire, and/or leakage of fluids.

Moreover, typically, a liner is disposed in the plug and cable to protect weld wire fed through the connector. The liner can be installed in the cable by inserting the liner through the power pin of the plug. Once installed, the liner isolates weld wire from the electrical current and/or a fluid flowing through the power pin and cable. Often, the liner is held in place by a bolt that traverses the power pin and engages a tip of the liner. The bolt may be loosened or tightened with a tool, e.g., screw driver, Allen wrench, etc., but over tightening of the bolt may cause damage to the liner, which may cause the weld wire to kink.

In view of at least the aforementioned issues, a connection system for efficiently and safely securing a liner within a torch cable, and/or connecting a torch cable to a power source and/or wire feeder are desirable.

### SUMMARY

An electrical connection system for an arc process system is disclosed herein. The electrical connection system includes a power pin and a receiving block. The power pin includes a rotational prevention element. The receiving block is configured to receive the power pin and includes a clamp assembly and one or more receptacles. The clamp assembly is configured to selectively engage the power pin to restrict axial movement of the power pin with respect to the receiving block. The one or more receptacles are configured to selectively engage the rotational prevention element and prevent rotational movement of the power pin with respect to the receiving block. Among other advantages, this electrical system ensures that reliable electrical, fluidic, and mechanical connections are provided in an arc process system. Other advantages and aspects are described herein.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is a schematic diagram of a robot welding system, according to an exemplary embodiment.

FIG. 2 is a perspective view of a wire feeder assembly with a partially transparent housing, according to an embodiment.

FIG. 3 is a rear perspective views of a connector in a disconnected configuration, according to an example embodiment.

FIG. 4 is a front perspective view of the connector of FIG. 3 in a locked configuration, according to an embodiment.

FIG. 5 is a sectional view of a portion of the connector of FIG. 3, taken along line 5-5 of FIG. 4.

FIG. 6 is a sectional view of a clamp included in the connector of FIG. 3 while in a closed position.

FIG. 7 is a side perspective view of the connector of FIG. 3, with certain portions of the connector's socket depicted transparently.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention. Embodiments of the invention are described with reference to a connector for a wire feeder and a welding torch cable, however embodiments are not limited thereto. For example, the connector may be used for connecting and transmitting power between any two components of a high-power system, such as a power source and a cable of a plasma cutting torch.

A conventional power pin of a plug for an arc processing operation (e.g., a welding or plasma cutting operation) generally includes only one or two portions having one or two diameters. For example, a conventional power pin may include an attachment portion for attaching to a cable and a second portion configured to be clamped into and receive one or more gases from a receiving block of a socket. In fact, with conventional power pins, a clamp of the receiving block may be configured to bear against the entire second portion. But, the second portion may also include various features, such as one or more grooves, bores, and/or protrusions configured to receive one or more of process gases, seals, holder screws, etc., complicating the clamping operation.

Additionally, when a conventional power pin is inserted into a receiving block of a socket, a user usually needs to hold the plug in place with one hand and clamp the second portion in the receiving block with a second hand. However, if one or more of surface features of the second portion are not properly aligned with corresponding structures in the receiving block during this two-handed clamping operations, fluids used during the arc processing operation may leak from the plug and socket. Moreover, even if the second portion is properly aligned within the receiving block, one or more of the surface features may obstruct the clamp of the receiving block resulting in a loose connection between the power pin and receiving block. The loose connection may allow the plug to fall out and/or cause a poor electrical connection, resulting in power losses during operation.

Still further, many conventional power connections for arc process operations attempt to restrict axial and rotation movement with a single element or structure. For example, many conventional power connections for arc process operations attempt to restrict axial and rotation movement with a single clamp that frictionally engages an outer surface (e.g., circumference) of a power pin. This can be inexact and can lead to unsafe and/or inefficient current transfer, fluid transfer, and/or mechanical locking. For example, if clamping allows axial movement, a plug might move out of exact alignment with a socket, preventing fluid transfer therebetween. As another example, if a clamp allows tilting or rotating, one side of the plug might move out of contact with a plug, creating an electrical transfer that is focused on one portion of the connection, which is inefficient, is potentially dangerous, and/or may cause rapid wear.

Generally, the system and method for connecting a torch cable to a wire feeder presented herein provide separate axial and rotational locking/restriction. Separating these functions increases the likelihood that each is successful. In fact, with the connection system presented herein, the axial locking/restriction may only engage subsequent to rotational locking/restriction, which may ensure the rotational locking/restriction is maintained during a connection. Still further, in at least some instances, the axial locking/restriction may only engage when the plug is fully inserted into the socket, which may ensure complete and efficient power transfer therebetween. That is, with the connection system presented herein, axial locking may create a reliable electrical connection. The connection system may also create a reliable fluid connection, since the fluid connection alignment may be tied to the reliable axial alignment utilized for the electrical connection.

In at least some embodiments, the connection system presented herein includes a plug having a multi-diameter power pin and a socket with a receiving block having a multi-diameter through hole, or bore, for receiving the power pin. The features of the power pin and receiving block may allow a user to connect and secure the plug to the socket with one hand. Moreover, in at least some embodiments, the plug may include a dedicated bearing portion of the power pin that provides an improved electrical connection between the pin and receiving block as compared to conventional connectors. That is, the dedicated bearing portion provides unobstructed contact between the power pin and receiving block. Thus, electricity may be efficiently conducted between the receiving block and power pin without the drawbacks of the conventional power pin noted above.

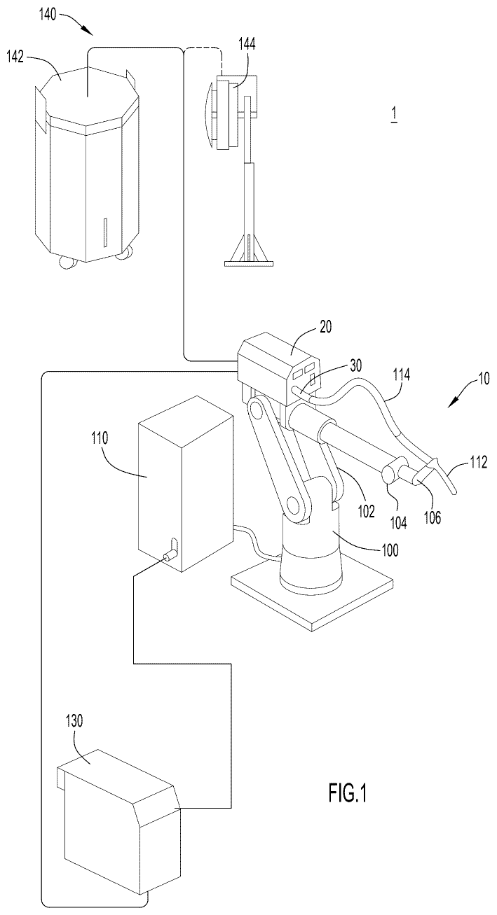

Referring to FIG. 1, a schematic diagram of an exemplary embodiment of a robot welding system 1, according to an embodiment is depicted. The robot welding system 1 includes a robot 10 connected to a controller 110, a wire feeder assembly 20, a power source 130, and wire supply 140. The power source 130 is electrically coupled to the robot 10 and the torch 112 via the controller 110, and the wire feeder assembly 20, respectively. The power source 130 can provide power to components of the robot 10, controller 110, and the wire feeder assembly 20, as well as a process current for an arc process (e.g., a welding or plasma cutting operation). Additionally, the power source 130 may provide a shield gas and/or a process gas for the plasma arc process to the wire feeder. The controller 110 controls the movement of the robot 10 and the plasma arc process. A wire supply 140 provides weld wire to the wire feeder assembly 20. The wire supply 140 may be a bulk pack 142 or a spool 144. In some implementations, the spool 144 is disposed in the wire feeder assembly 20.

In the depicted embodiment, the robot 10 includes a base 100, a first arm 102 pivotably attached to and extending from the base 100, and a second arm 104 pivotably coupled to the first arm 102, opposite the base 100. A torch 112 is disposed on a distal end 106 of the second arm 104, and the wire feeder assembly 20 is disposed at a coupling between the first arm 102 and second arm 104. However, this is just one example of a welding robot and the present application may be applicable to a wide variety of robots.

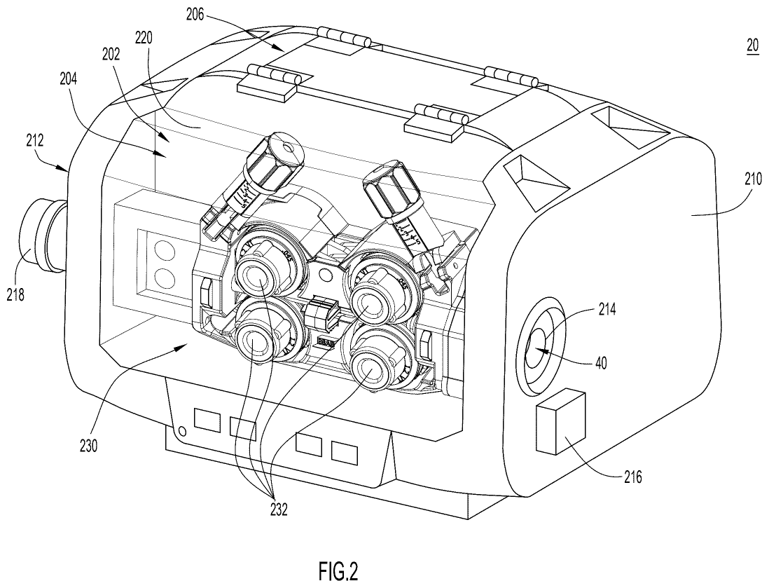

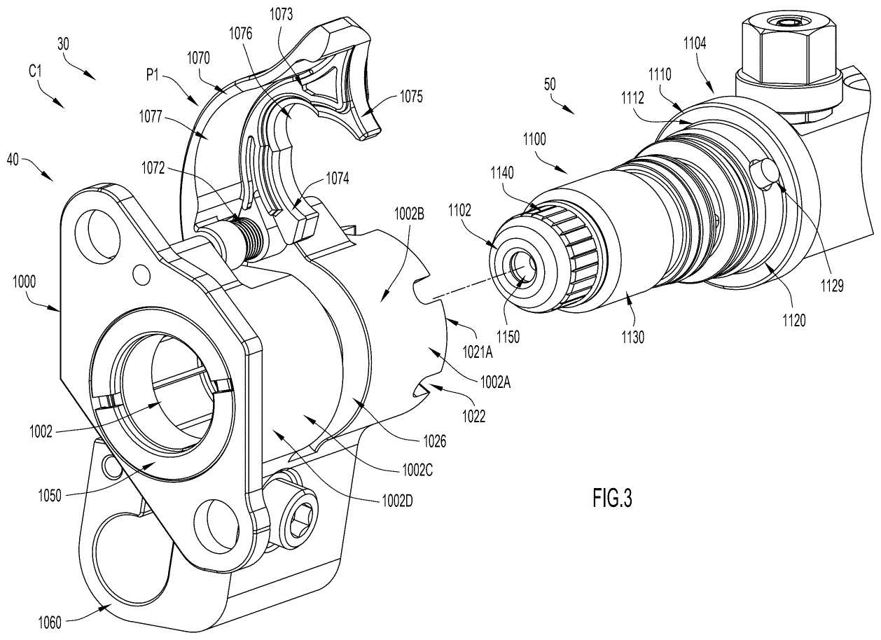

Regardless of the exact configuration of the robot and the location of the wire feeder assembly 20 on the robot, a torch cable 114 connects the torch 112 to the wire feeder assembly 20. A connector 60 couples the torch cable 114 to the wire feeder assembly 20. The connector includes a socket 70 disposed at the wire feeder assembly 20 (see FIG. 2) and a plug 80 disposed on the torch cable 114 (see FIGS. 3-5). During a weld operation, the torch cable 114 transmits a process current, weld wire, and fluids (e.g., shield gas, process gas, and/or cooling fluid) from the wire feeder assembly 20 through the connector 60 and torch cable 114 to the torch 112.

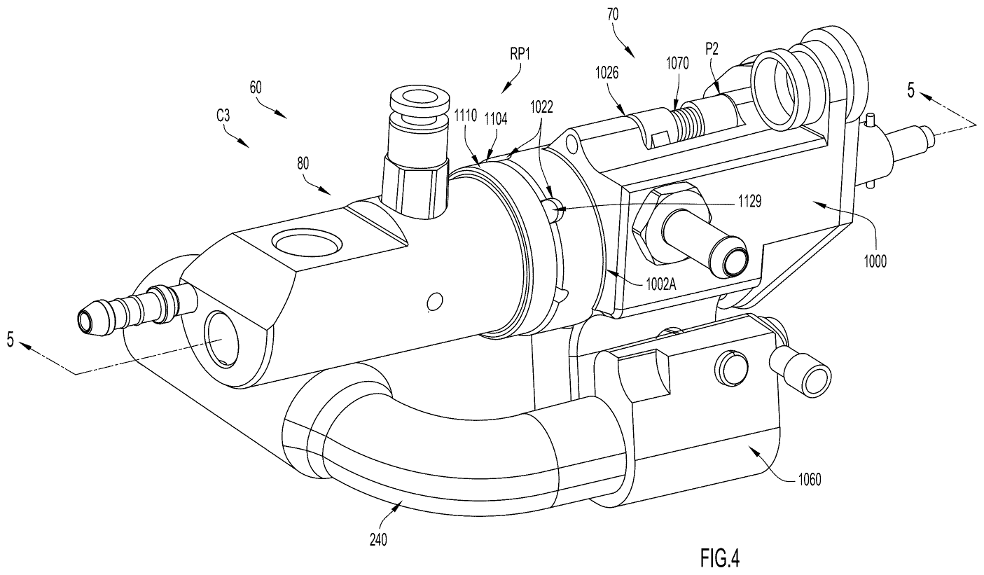

FIG. 2 is a side perspective view of a wire feeder assembly 20 according to an embodiment. The wire feeder assembly 20 includes an outer housing 200 having a front face 210 and a rear face 212. The front face 210 includes a connector port 214 and a power port 216 that each define passageways through the front face 210 to an interior compartment 202 defined by the housing 200. The connector port 214 provides a passage for a plug 50 of the connector 30 to be inserted into the socket 40. A conductor 240 (See FIG. 4) for conducting arc process power can be inserted through the power port 216 and electrically coupled to the socket 40. As is detailed below, a receiving block 1000 of the socket 40 is disposed between and aligned with a feeder 230 disposed in the interior compartment 202 and the connector port 214. The receiving block 1000 is configured to receive the plug 50 of the connector 30 and the conductor 240.

In the depicted embodiment, a divider wall 220 within the housing 200 divides the interior compartment 202 into a wire feeding side 204 and a control side 206. The wire feeding side 204 houses a socket 40 of the connector 30 and the feeder 230 for pulling weld wire through a wire port 218 in the rear face 212. The feeder 230 includes a plurality of wire rollers 232 for pulling the weld wire from a wire supply 140 through the wire port 218 and pushing the weld wire through the socket 40. The control side 206 includes components and/or circuitry for receiving signals and controlling the feeder 230 based on the received signals. In some implementations, the components and/or circuitry may control one or more arc process parameters (e.g., process power, process current, voltage, process gas flow, shield gas flow, cooling fluid flow, wire feed speed, etc.).

Now turning to FIGS. 3 and 4, the connector 30 presented herein can be positioned in at least three configurations. FIG. 3 depicts a first configuration C1 (i.e., a disconnected configuration) where a clamp assembly 1070 is in an open position P1 and the plug 50 is disconnected from the socket 40. FIG. 4 depicts a third configuration C3 (i.e., a locked configuration) where the plug 50 is inserted in the socket 40 and the clamp assembly 1070 is in a closed position P2. The second configuration, which is not pictured, is a midpoint or temporary configuration (i.e., a provisional configuration) where the plug 50 is inserted in the socket 40 (e.g., as shown in FIG. 4), but the clamp assembly 1070 is in the open position P1 (e.g., as shown in FIG. 3). As is detailed below, the socket 40 may include a conductive insert 1050 that can temporarily or provisionally retain the plug 50 in the second configuration after the plug 50 is inserted into the socket 40 while the clamp assembly 1070 is moved from its first position P1 to its second position P2. Consequently, a user can use one hand to connect the plug 50 to socket 40.

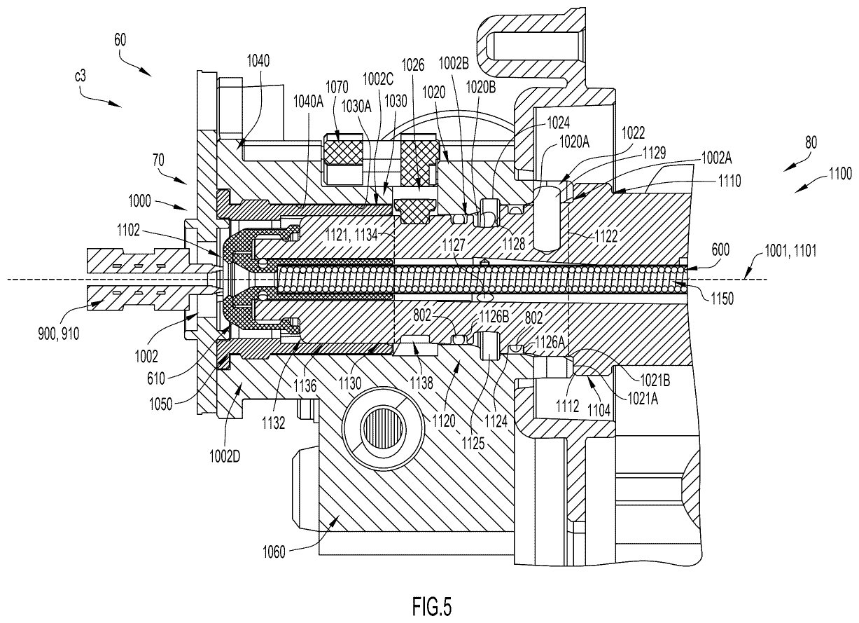

The socket 40 of the connector 30 presented herein generally includes a receiving block 1000 having a multi-diameter through hole or central bore 1002 for receiving the power pin 1100. Meanwhile, the plug 50 of the connector 30 presented herein generally extends from a distal end 1102 to a proximal end 1104 that is connectable to a torch cable. A multi-diameter power pin 1100 is disposed at the distal end 1102. The power pin 1100 is generally configured to receive arc process power (e.g., a weld or plasma cutting current), shield gases, arc process gases, and/or cooling fluid from the receiving block 1000. More specifically, the power pin 1100 includes a central bore 1150 that extends through the length of the power pin 1100 along a longitudinal axis 1101 (see FIG. 5). The central bore 1150 provides a path through the power pin 1100 for process power, process and/or shield gases, and weld wire, at least some of which may be received from feeder 230.

As can be seen in FIG. 3, the power pin 1100 includes a proximal portion 1110, an engagement portion 1120 extending from the proximal portion 1110, a bearing portion 1130 extending from the engagement portion 1120, and a threaded distal portion 1140 extending from the bearing portion 1130. The proximal portion 1110 of the power pin 1100 generally has a diameter that is larger than one or more diameters of the engagement portion 1120. But, at least a portion of the engagement portion 1120 may also have a diameter that is larger than a diameter of the bearing portion 1130. The distal portion 1140 may also have a diameter smaller than a diameter of at least a portion of the engagement portion 1120. Or, in short, power pin 1100 may generally decrease in diameter (via various steps) from its proximal end 1104 to its distal end 1102. Thus, in at least some respects, be similar to the power pin disclosed in U.S. Application Ser. No. 17/215,436, filed Mar. 29, 2021, which is hereby incorporated by reference in its entirety. Nevertheless, each of the proximal portion 1110, the engagement portion 1120, the bearing portion 1130 and the threaded portion 1140 are described in turn below.

First, and still referring to FIGS. 3 and 4, but now in combination with FIG. 5, one end of the proximal portion 1110 is generally configured to attach to the torch cable 114 (See FIG. 1). At the other end, the proximal portion 1110 may include includes an annular face 1112 configured to be positioned in close proximity to the socket 40 when the connector 30 is in its locked configuration C3. For example, the annular face 1112 may abut a lateral annular face 1021A of the bore inlet 1002A of the socket 40 when the connector 30 is in its locked configuration C3. The annular face 1112 also defines a step, where the power pin 1100 transitions from the proximal portion 1110 to the engagement portion 1120.

Second, in the depicted embodiment, the engagement portion 1120 extends from a proximal end 1122 to a distal end 1121 (delineated with dashed lines in FIG. 5) and includes an outer surface 1124 with various features formed therein. Moving from the proximal end 1122 to the distal end 1121, the outer surface 1124 includes a radial protrusion 1129, a first annular seal seat 1126A, a first annular groove 1125, a second annular seal seat 1126B, and a second annular groove 1138 formed therein. Additionally, in the depicted embodiment, the outer surface 1124 is stepped at step 1128 so that the engagement portion 1120 includes multiple diameters. In particular, a first portion of the outer surface 1124 includes a larger diameter and extends from the proximal portion 1110 to the annular groove 1125. Then, the annular groove 1125 is formed at or defines the step 1128 so that a second portion of the outer surface 1124 includes a smaller diameter and extends from the annular groove 1125 to the bearing portion 1130. However, other embodiments need not include a step 1128 or may include more than one steps 1128.

In the depicted embodiment, the larger diameter section of the outer surface 1124 includes a radial protrusion 1129 that extends radially beyond the outer surface 1124. As is detailed below, the radial protrusion 1129 is generally configured to engage receptacles 1022 (i.e., rotational restriction slots) in an outer lateral surface of the receiving block 1000 - e.g., the lateral annular face 1021A of the bore inlet 1002A of the receiving block 1000. When engaged as such, the radial protrusion 1129 may restrict or prevent rotational movement of the power pin 1100 with respect to the receiving block 1000.

In the depicted embodiment, the radial protrusion 1129 is configured to engage one of the receptacles 1022 because the radial protrusion 1129 is substantially cylindrical and the receptacles 1022 are hemispherical. Thus, the radial protrusion 1129 and the receptacles 1022 can closely conform when abutting or in close proximity with each other. However, in other embodiments, radial protrusion 1129 and/or receptacles 1022 may be any shape and/or dimension that allows these features to engage and prevent or restrict rotational movement of the power pin 1100 with respect to the receiving block 1000 when the power pin 1100 is installed in the receiving block 1000. Moreover, while the depicted embodiment shows one radial protrusion 1129, other embodiments might include any number of radial protrusion 1129. As an example, some embodiments might include a plurality of radial protrusion 1129 spaced around a circumference of the power pin 1100. The angular spacing around the power pin 1100 can be any desired spacing but preferably matches a spacing of receptacles 1022 on the receiving block 1000, e.g., to allow the power pin 1100 and receiving block 1000 to be connected in a variety of angular alignments or one or more specific angular alignments.

The first annular groove 1125 and the second annular groove 1138 each extend radially inward from the outer surface 1124. However, grooves 1125 and 1138 may serve different purposes. The first annular groove 1125 is generally configured to fluidly couple the power pin 1100 to the receiving block 1000. Meanwhile, the second annular groove 1138 is generally configured to help restrict axially movement of the power pin 1100 with respect to the receiving block 1000 when the connector 30 is in its locked configuration C3.

More specifically, the first annular groove 1125 may be fluidly coupled to the central bore 1150 by one or more holes 1127 (also referred to as channels) that extend radially (but not necessarily radially) between the central bore 1150 and the annular groove 1125. Thus, a process gas and/or shield gas may flow through the annular groove 1125 and the radial channels to the central bore 1150. To prevent leakage, the annular groove 1125 is axially bounded by the first annular seal seat 1126A and the second annular seal seat 1126B, each of which extend radially inward from the outer surface 1124 and receive a seal 802. That is, the first annular seal seat 1126A is disposed between the proximal end 1122 of the engagement portion 1120 and the annular groove 1125 while the second annular seal seat 1126B is disposed between the distal end 1121 of the engagement portion 1120 and the annular groove 1125. Put still another way, the first annular seal seat 1126A is disposed downstream from the annular groove 1125 and the second annular seal seat 1126B is disposed upstream of the annular groove 1125. However, in other embodiments, these seals and seal seats could be included in the receiving block 1000.

Third, the bearing portion 1130 of the power pin 1100 is configured to be securely engaged, or “bared on,” by the receiving block 1000, or components thereof. The bearing portion 1130 is dedicated to providing a large contact area, free of obstructions, for the receiving block 1000 to engage and form a secure, reliable electrical connection. Thus, in the depicted embodiment, the bearing portion 1130 extends from a proximal end 1134 to a distal end 1132 and has a smooth outer surface 1136 disposed therebetween. Said another way, the outer surface 1136 does not include any surface protrusions or depressions.

Accordingly, the smooth outer surface 1136 provides a large contact area with which an inner surface of the receiving block 1000, or a component installed therein, can engage in the locked configuration C3. Or, more specifically, the smooth outer surface 1136 provides a large bearing contact with which the conductive insert 1050 of the receiving block 1000 can engage in the locked configuration C3. Thus, the bearing portion 1130 allows for efficient and reliable transmission of electricity between the receiving block 1000 and power pin 1100, reducing power losses for components that are coupled together with connector 30.

Fourth, the final section of the power pin 1100 is distal portion 1140. Distal portion 1140 includes a threaded exterior portion that can be removably coupled to a liner cap 610. In turn, the liner cap 610 can be coupled to a liner 600. Thus, securing the liner cap 610 to the threaded portion 1140 can secure liner 600 within the central bore 1150 of the power pin 1100. The liner 600 generally comprises an elongated tube defining a conduit for receiving welding wire (or other such consumables) and is configured to isolate the weld wire from the inner surface of the power pin 1100 and process and/or shield gasses flowing through the central bore 1150. In fact, in at least some embodiments, the liner 600 and/or the liner cap 610 may be the same or similar to the liner and/or liner cap, respectively, disclosed in U.S. Application No. Ser. No. 17/215,436, filed Mar. 29, 2021, which, to reiterate, is incorporated by reference in its entirety. Among other advantages, such liners and liner caps may allow installation, maintenance, and/or replacement without tools.

Still referring to FIGS. 3-5, but now with a particular emphasis on FIG. 5, the socket 40 and its receiving block 1000 are generally configured to mate with the power pin 1100 and its various features. Thus, among other features, the receiving block 1000 includes a multi-diameter central bore 1002 extending along a longitudinal axis 1001 of the receiving block 1000. The central bore 1002 is generally configured to receive the multi-diameter power pin 1100 and includes: (1) a bore inlet 1002A configured to receive and/or mate with the proximal portion 1110 and a first portion of the engagement portion 1120; (2) a first bore section 1002B (also referred to as a receiver section) configured to receive and/or mate with a second portion of the engagement portion 1120; (3) a third bore section 1002C configured to receive and/or mate with the bearing portion 1130; and (4) a distal bore section 1002D configured to receive and/or mate with the threaded portion 1140.

To form these various bore sections, the receiving block 1000 includes a receiver 1020, an engagement portion 1030, and a distal portion 1040. First, the receiver 1020 has multiple inner diameters so that it can define a first bore diameter for bore inlet 1002A and a first portion of the first bore section 1002B, as well as a second bore diameter for a second portion of the first bore section 1002B. The second bore diameter is smaller than the first bore diameter. Then, the engagement portion 1030 defines a constant third diameter for the third bore section 1002C. In at least some embodiments, the third diameter is substantially equal to the second bore diameter (of receiver 1020). Finally, the distal portion 1040 defines a relatively constant diameter for the distal bore section 1002D that may also be substantially equal to the second bore diameter, except that the distal bore section 1002D may include features that can secure the conductive insert 1050 therein.

As can be seen in FIGS. 3 and 5, the bore inlet 1002A defined by the receiver 1020 includes an inner surface 1021B with a frustoconical shape and a lateral annular face 1021A. From the perspective of a wire feeder in or on which the socket 70 is included, the lateral annular face 1021A is the most exteriorly orientated portion of the receiving block 1000. Critically, this lateral annular face 1021A includes receptacles 1022 formed therein (e.g., extending axially into the lateral annular face 1021A). As mentioned, each of the receptacles 1022 are sized and shaped to receive the radial protrusion 1129 of the proximal portion 1110. This allows the receiving block 1000 to rotationally secure the power pin 1100 with respect to the receiving block 1000 (e.g., as shown in FIG. 4).

Locating the receptacles 1022 on the lateral annular face 1021A is critical because the lateral annular face 1021A faces a plug 80 to be inserted into the socket 70. Thus, when the plug 80 is fully inserted into the socket 70 (e.g., when connector 30 is in the locked configuration C3), the proximal portion 1110 of the plug 80—which resembles a flange—is disposed in close proximity to (e.g., abuts) the lateral annular face 1021A. This ensures that the radial protrusion 1129 prevents rotation of the power pin 1100 with respect to the receiving block 1000 only when the power pin 1100 is full installed within the central bore 1002 of the receiving block 1000. In fact, in at least some embodiments, the proximal portion 1110 impacts the lateral annular face 1021A to create haptic, visual, and/or acoustic feedback when the plug 80 is fully inserted into the plug 80 (e.g., when connector 30 is in locked configuration C3).

Now turning to FIG. 5 specifically, beyond the bore inlet 1002A, the receiver 1020 also defines inner surfaces 1020A and 102B, and an annular groove 1024. Inner surfaces 1020A and 1020B are configured to engage the different diameters of the outer surface 1124 of the engagement portion 1120 of the power pin 1100. Specifically, in the depicted embodiment, inner surface 1020A has a larger interior diameter and can engage the larger portion of outer surface 1124 of the engagement portion 1120. Meanwhile, inner surface 1020B has a smaller interior diameter and can engage a smaller portion of the outer surface 1124 of the engagement portion 1120. The annular groove 1024, on the other hand, extends radially outward from inner surface 1020A and/or inner surface 1020B and can cooperate with the annular groove 1125 of the engagement portion 1120 to define a fluid passageway for arc process gases.

Although not shown, the annular groove 1024 may also be connected to a fluid channel that couples the annular groove 1024 to an external gas source. Thus, the annular groove 1125 can serve to fluidly couple the receiving block 1000 to the one or more holes 1127 formed through the power pin 1100 (e.g., via annular groove 1125), which provide a fluid path from an outer surface of the power pin 1100 to the central bore 1150 of the power pin 1100. Or, put simply, the annular groove 1125 can serve to fluidly couple the central bore 1150 of the power pin 1100 to a flow of gas (e.g., from wire feeder assembly 20).

Still referring to FIG. 5, but now in combination with FIGS. 3, 4, and 7, the receiver 1020 also includes a clamp groove 1026. The clamp groove 1026 extends entirely through at least an angular portion of the receiver 1020 to intersect the first bore section 1002B and allow at least a portion of the clamp assembly 1070 to extend into the central bore 1002 of the receiving block 1000. As can be seen in FIG. 5, the clamp groove 1026 is configured to align with the second annular groove 1138 of the power pin 1100 when the power pin 1100 is fully inserted into the receiving block 1000 (e.g., when the connector 30 is in the locked configuration C3 or a provisional configuration prior to the locked configuration C3). Then, the clamp assembly 1070 may move to a fully closed position P2 in which the clamp assembly 1070 axially secures the power pin 1100 in the receiving block 1000.

Importantly, the clamp assembly 1070 may not be able to completely move into its closed position P2 until it engages the second annular groove 1138 of the power pin 1100. In view of this and the position of the clamp groove 1026 (which aligns with second annular groove 1138 when power pin 1100 is fully inserted into receiving block 1000), the clamp assembly 1070 may only be movable to a fully closed position P2 in specific instances. These instances may be when a conductive portion of the receiving block (e.g., conductive insert 1050 and/or engagement portion 1030) fully engages a bearing portion 1130 of the power pin 1100 to electrically couple the power pin 1100 to the receiving block 1000. Or, put simply, the clamp assembly 1070 may only be locked into closed position P2 when a complete and reliable electrical connection is formed between the power pin 1100 and the receiving block 1000 (e.g., via conductive insert 1050 and bearing portion 1130).

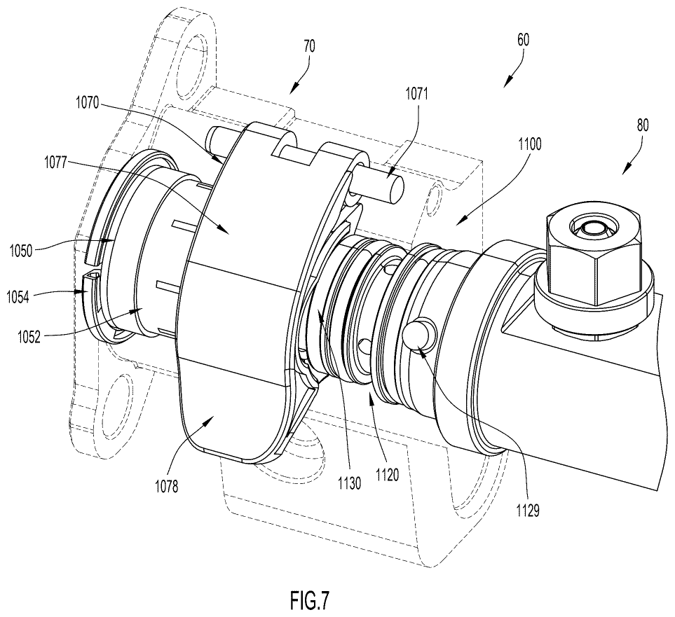

Now turning again to FIG. 5 alone, the engagement portion 1030 and the distal portion 1040 generally define an interior cavity sized to receive the conductive insert 1050 and position the conductive insert 1050 against the bearing portion 1130 of the power pin 1100. As can be seen in FIG. 7, the conductive insert 1050 is a flexible crown-style insert, with a plurality of fingers 1052 extending from a base or flange 1054. Adjacent resilient fingers 1052 are separated by gaps and, thus, each of the resilient fingers 1052 is independently resilient or pliable. Consequently, when the threaded portion 1140 is inserted into the power pin 1100, the resilient fingers 1052 may urge the threaded portion 1140 to a centered alignment. Additionally, or alternatively, the resilient fingers 1052 may fully engage a circumference of the power pin 1100 in a variety of positions, orientations, and/or alignments (e.g., tilted in any direction, offset axially from a central axis, etc.).

In view of this, the engagement portion 1030 has a substantially constant interior surface 1030A to evenly support distal ends of the resilient fingers 1052 and set a consistent outer boundary to which the distal ends of the resilient fingers 1052 may flex. Similarly, the distal portion 1040 has a substantially constant interior surface 1040A to support bases of the resilient fingers 1052, but may also include features that can secure the flange 1054 of the conductive insert 1050 within the distal portion 1040 of the receiving block 1000. For example, the inner surface 1040A may include one or more grooves, slots, or other such features, and the conductive insert 1050 may be press fit to press corresponding protrusions into these features (or vice versa) and secure the conductive insert 1050 in the receiving block 1000.

Now referring again to FIGS. 3-5, in addition to the foregoing features, the receiving block 1000 also includes a U-shaped coupler 1060 extending from a bottom of both receiver 1020 and engagement portion 1030. The coupler 1060 is configured to receive the arc process power conductor 240. During operation, power from the conductor 240 is conducted through the receiving block 1000 to the power pin 1100 and then conducted through one or more cable adapters and/or cable conductors that carry the current to an arc process torch 112. For example, an electric current may be conducted from the U-shaped coupler 1060 to the bearing portion 1130 via the engagement portion 1030 and/or conductive insert 1050. Additionally, process gas flows from the wire feeder assembly 20 through the receiving block 1000 into the central bore 1150 via annular groove 1024 and/or annular groove 1125. The process gas may then flow around the liner 600 to another channel, one or more adapters, and/or one or more conductors to a process torch 112.

In addition to power and process gas, a weld wire is guided through the power pin 1100 and torch cable 114 to the torch 112. As discussed above, weld wire is pulled from a wire supply 140 by wire rollers 232 and is isolated from electrical currents and process gases by the liner 600. In at least some embodiments, a wire guide 900, which may be supported in the feeder assembly 20 by a guide support 910, receives the weld wire from the wire rollers 232 and guides the weld wire to the multi-diameter central bore 1002 via the distal portion 1140 of the power pin 1100 and/or with liner cap 610. The liner 600 (which extends through the torch cable 114 to the torch 112) then guides the weld wire to the torch 112 where it is consumed in an arc welding process. The liner 600, liner cap 610 (potentially in combination with a liner tip) isolate weld wire received from gas and power flowing through the power pin 1100 and receiving block 1000.

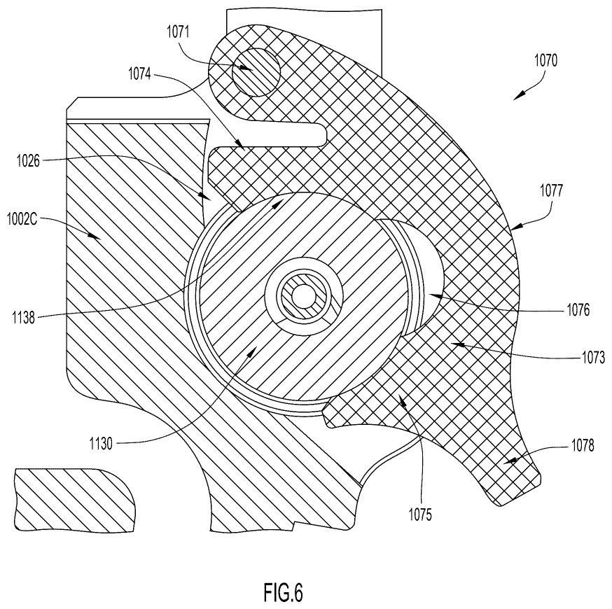

Now turning to FIGS. 6 and 7, in the depicted embodiment, the clamp assembly 1070 comprises a biased, lever-style clamp. Thus, the clamp assembly 1070 includes a lever-style clamp element 1073 mounted on an axle 1071. In at least some embodiments, the axle 1071 includes a biasing element 1072 (e.g., a torsion spring) that biases the clamp assembly 1070 towards its open position P1. However, the clamp element 1073 may be specifically designed to engage the power pin 1100 in a manner that overcomes the biasing of the biasing element 1072 and secures the clamp assembly 1070 to the power pin 1100.

More specifically, the clamp element 1073 may include a first member 1074 and a second member 1075 that opposes the first member 1074. Between the first member 1074 and the second member 1075, the clamp element 1073 may include a recess extension 1076 that allows the first member 1074 and second member 1075 to flex with respect to each other. Thus, when the clamp element 1073 is pressed into contact with the power pin 1100, the first member 1074 and second member 1075 may flex around the outer circumference of the power pin 1100, engaging opposite sides of the power pin 1100 (e.g., opposite ends of a diameter of the power pin 1100).

However, in at least some embodiments, the first member 1074 and second member 1075 may not fully lock into place until they are aligned with the second annular groove 1138 of the engagement portion 1120. When such an alignment is achieved, the clamp assembly 1070 may engage the power pin 1100 to: (a) prevent axial movement of the power pin 1100 with respect to the receiving block 1000; (b) lock rotational restriction features into engagement; (c), ensure a reliable, complete electrical connection between the power pin 1100 and receiving block 1000; and (d) create a sealed fluidic connection between the power pin 1100 and receiving block 1000.

This is because the first member 1074 and second member 1075 may flex around the outer circumference of the second annular groove 1138 of the engagement portion 1120 of the power pin 1100 and closely engage this groove 1138. In fact, the inner surfaces of the first member 1074 and second member 1075 may each be contoured to match a contour of the second annular groove 1138 of the engagement portion 1120. Thus, when the first member 1074 and second member 1075 flex around and engage the groove 1138, the first member 1074 and second member 1075 may lock into place. Indeed, in some embodiments, the first member 1074 and second member 1075 may snap into place, creating haptic and/or acoustic feedback that positive locking has occurred. Additionally or alternatively, the first member 1074 and second member 1075 might create haptic and/or acoustic feedback in any other manner. Still further, since the clamp assembly 1070 overcomes biasing when locking into place, the clamp assembly 1070 may be stiff and immobile once locked in place, providing visual feedback that positive locking has occurred.

When the clamp assembly 1070 is moved into a locked position P2, the clamp assembly 1070 may secure the connector 30 in its locked configuration C3. The connector 30 will then remain in this connection until the clamp assembly 1070 is opened and/or disengaged. In at least some embodiments, the clamp assembly 1070 includes a cover 1077 with a release flange 1078 to help a user grasp and open the clamp assembly 1070 to move the clamp assembly 1070 to its open position P1. Then, the power pin 1100 can be removed from the receiving block 1000, during which the radial protrusion 1129 may disengage from one of receptacles 1022.

Among other advantages, the connector 30 presented herein allows a user to, with one hand, insert the power pin 1100 into a receiving block 1000 and provisionally lock the plug 50 (e.g., via the resilient fingers 1052 of the conductive insert 1050) into the socket 40. Then, the user can release the torch cable 114, and clamp and secure the power pin 1100 in place within the receiving block 1000. Moreover, once secured in a locked configuration, the connector 30 provides independent axial and rotation locking. At least because these locking features are separate and independent, failure of one will not impact the other. This provides an added layer of safety. Also, because these locking features are separate and independent, the features can be relatively non-complex and reliable, thereby ensuring that the connector 30 provides reliable mechanical, electrical, and fluidic couplings. In fact, embodiments of the present application may ensure that axial and rotational restrictions may only be completed when reliable mechanical, electrical, and fluidic couplings are in place. Accordingly, electricity and fluid may be efficiently transmitted from the receiving block 1000 to the power pin 1100 without the drawbacks of other couplings for arc process systems.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the connector 30 described herein, or portions thereof may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Further, the terms “upstream” and “downstream” are considered in relation to a path of the weld wire (e.g., from the wire guide 900 to the cable conductor 115 in FIG. 7). Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

Clause 1. An electrical connection system for an arc process system, comprising:
a power pin comprising a rotational prevention element; and a receiving block configured to receive the power pin, the receiving block comprising: a clamp assembly configured to selectively engage the power pin to restrict axial movement of the power pin with respect to the receiving block; and one or more receptacles configured to selectively engage the rotational prevention element and restrict rotational movement of the power pin with respect to the receiving block.

Clause 2. The electrical connection system of clause 1, wherein the receiving block further comprises a conductive portion configured to engage the power pin to electrically couple the power pin to the receiving block.

Clause 3. The electrical connection system of clause 2, wherein the conductive portion comprises an insert with resilient fingers.

Clause 4. The electrical connection system of clause 2, wherein:
the power pin comprises a bearing portion and an engagement portion, the engagement portion including the rotational prevention element; and in a locked configuration of the electrical connection system, the conductive portion of the receiving block engages the bearing portion to electrically couple the power pin to the receiving block while the clamp assembly and the one or more receptacles engage the engagement portion of the power pin.

Clause 5. The electrical connection system of clause 4, wherein the bearing portion has a first diameter and at least a portion of the engagement portion has a second diameter that is larger than the first diameter.

Clause 6. The electrical connection system of clause 5, wherein the power pin further comprises a proximal portion with a third diameter that is larger than the second diameter, the proximal portion being configured to be positioned in close proximity to an end lateral face of the receiving block.

Clause 7. The electrical connection system of clause 5, wherein the power pin further comprises a distal portion with a third diameter that is smaller than the first diameter, the distal portion being configured to directly or indirectly support a liner that extends axially through a central bore of the power pin.

Clause 8. The electrical connection system of clause 1, wherein the power pin comprises a groove configured to receive a portion of the clamp assembly in a locked configuration of the electrical connection system.

Clause 9. The electrical connection system of clause 8, wherein the groove is axially spaced from a distal end of the power pin by a bearing portion of the power pin so that the bearing portion of the power pin is axially restrained upstream of the groove in the locked configuration of the electrical connection system.

Clause 10. The electrical connection system of clause 8, wherein the clamp assembly comprises a clamp element with a first member and a second member configured to engage opposite sides of the groove.

Clause 11. The electrical connection system of clause 8, wherein the clamp assembly is biased to an open position, and the electrical connection system is not in the locked configuration when the clamp assembly is in the open position.

Clause 12. The electrical connection system of clause 8, wherein the clamp assembly provides visual feedback, haptic feedback, acoustic feedback, or some combination thereof, in response to being secured in a closed position, which moves the electrical connection system into the locked configuration.

Clause 13. The electrical connection system of clause 1, wherein the clamp assembly is only movable to a fully closed position in which the clamp assembly axially secures the power pin in the receiving block when a conductive portion of the receiving block fully engages a bearing portion of the power pin to electrically couple the power pin to the receiving block.

Clause 14. The electrical connection system of clause 13, wherein any one of the one or more receptacles can engage the rotational prevention element and restrict rotational movement of the power pin with respect to the receiving block when the conductive portion of the receiving block fully engages the bearing portion of the power pin.

Clause 15. The electrical connection system of clause 1, wherein the power pin further comprises one or more through holes and the receiving block is configured to direct a fluid to the one or more through holes.

Clause 16. The electrical connection system of clause 15, wherein the receiving block directs the fluid to the one or more channels via an annular channel that is axially bounded by seals.

Clause 17. A power pin for an arc process system, comprising: a bearing portion configured to electrically couple the power pin to a conductive portion of a receiving block; and an engagement portion, including: a rotational prevention element configured to selectively engage a receptacle of the receiving block to prevent rotational movement of the power pin with respect to the receiving block; and a groove configured to receive a portion of a clamp assembly of the receiving block to prevent axial movement of the power pin with respect to the receiving block.

Clause 18. The power pin of clause 17, wherein the rotational prevention element comprises a protrusion configured to sit within the receptacle when the power pin is fully installed within the receiving block.

Clause 19. A receiving block for an arc process system, comprising: a bore inlet with a lateral annular face that includes one or more receptacles in which a rotational prevention element of a power pin can be selectively secured; a first bore section configured to axially secure the power pin with respect to the receiving block and to direct a fluid through one or more through holes in the power pin; and a second bore section configured to electrically couple the receiving block to the power pin.

Clause 20. The receiving block of clause 19, wherein the receiving block comprises a clamp assembly that axially secures the power pin with respect to the receiving block.

Clause 21. The receiving block of clause 20, wherein the first bore section comprises a clamp groove extending radially through the first bore section, along an angular portion of the first bore section, to allow the clamp assembly to extend into a central bore of the receiving block.

Clause 22. The receiving block of clause 19, wherein the second bore section includes a conductive insert with resilient fingers configured to electrically couple the receiving block to the power pin.

Clause 23. The receiving block of clause 19, wherein the power pin is inserted into the receiving block via the bore inlet and the first bore section is disposed between the bore inlet and the second bore section.

Clause 24. The receiving block of clause 23, wherein the second bore section has a second diameter and at least a portion of the first bore section has a first diameter that is larger than the second diameter.

Clause 25. The receiving block of clause 19, wherein the first bore section comprises an interior groove configured to form an annular fluid channel that directs the fluid through the one or more through holes in the power pin.

What is claimed is:

1. A power pin for an electrical connection system for an arc process system, the power pin comprising:
a bearing portion configured to electrically couple the power pin to a conductive portion of a receiving block; and
an engagement portion, including:
a rotational prevention element configured to selectively engage a receptacle of the receiving block to prevent rotational movement of the power pin with respect to the receiving block; and
a groove configured to receive a portion of a clamp assembly of the receiving block to prevent axial movement of the power pin with respect to the receiving block.

2. The power pin of claim 1, wherein the rotational prevention element comprises a protrusion configured to sit within the receptacle when the power pin is fully installed within the receiving block.

3. The power pin of claim 1, wherein in a locked configuration of the electrical connection system, the bearing portion engages the conductive portion of the receiving block to electrically couple the power pin to the receiving block while the clamp assembly engages the groove and the rotational prevention element engage the engagement portion of the power pin.

4. The power pin of claim 1, wherein the bearing portion has a first diameter and at least a portion of the engagement portion has a second diameter that is larger than the first diameter.

5. The power pin of claim 4, wherein the power pin further comprises a proximal portion with a third diameter that is larger than the second diameter, the proximal portion being configured to be positioned in close proximity to an end lateral face of the receiving block.

6. The power pin of claim 4, wherein the power pin further comprises a distal portion with a fourth diameter that is smaller than the first diameter, the distal portion being configured to directly or indirectly support a liner that extends axially through a central bore of the power pin.

7. The power pin of claim 1, wherein the groove is axially spaced from a distal end of the power pin by the bearing portion of the power pin so that the bearing portion of the power pin is axially restrained upstream of the groove in a locked configuration of the electrical connection system.

8. The power pin of claim 1, wherein the rotational prevention element engages the receptacle when the bearing portion fully engages the conductive portion of the receiving block.

9. A receiving block for an electrical connection system for an arc process system, the receiving block comprising:
a bore inlet with a lateral annular face that includes one or more receptacles in which a rotational prevention element of a power pin can be selectively secured;
a first bore section configured to axially secure the power pin with respect to the receiving block and to direct a fluid through one or more through holes in the power pin; and
a second bore section configured to electrically couple the receiving block to the power pin.

10. The receiving block of claim 9, wherein the first bore section comprises an interior groove that directs the fluid through the one or more through holes in the power pin, the interior groove being axially bounded by seals.

11. The receiving block of claim 9, wherein the receiving block comprises a clamp assembly that axially secures the power pin with respect to the receiving block.

12. The receiving block of claim 11, wherein the first bore section comprises a clamp groove extending radially through the first bore section, along an angular portion of the first bore section, to allow the clamp assembly to extend into a central bore of the receiving block.

13. The receiving block of claim 11, wherein the clamp assembly is biased to an open position, and the electrical connection system is not in a locked configuration when the clamp assembly is in the open position.

14. The receiving block of claim 11, wherein the clamp assembly provides visual feedback, haptic feedback, acoustic feedback, or some combination thereof, in response to being secured in a closed position, which moves the electrical connection system into a locked configuration.

15. The receiving block of claim 11, wherein the clamp assembly comprises a clamp element with a first member and a second member configured to engage opposite sides of the power pin.

16. The receiving block of claim 11, wherein the clamp assembly is only movable to a fully closed position in which the clamp assembly axially secures the power pin in the receiving block when a conductive portion of the receiving block fully engages a bearing portion of the receiving block to electrically couple the power pin to the receiving block.

17. The receiving block of claim 9, wherein the power pin is inserted into the receiving block via the bore inlet and the first bore section is disposed between the bore inlet and the second bore section.

18. The receiving block of claim 9, wherein the second bore section has a second diameter and at least a portion of the first bore section has a first diameter that is larger than the second diameter.

19. The receiving block of claim 9, wherein the second bore section includes a conductive insert with resilient fingers configured to electrically couple the receiving block to the power pin.

20. The receiving block of claim 9, wherein any one of the one or more receptacles can engage the rotational prevention element and restrict rotational movement of the power pin with respect to the receiving block when the second bore section fully engages a bearing portion of the power pin.
